(19) United States
(12) Patent Application Publication
(10) Pub. No.: US 2006/0097875 A1
(43) Pub. Date: May 11, 2006

(54) Sensor device, monitoring system, and method for using a monitoring system for monitoring merchandise

(76) Inventor: Reinhold Ott, Waterloo (CA)

Correspondence Address: HARNESS, DICKEY & PIERCE, P.L.C., P.O. BOX 8910, RESTON, VA, 20195, US

(21) Appl. No.: 11/188,709

(22) Filed: Jul. 26, 2005

(30) Foreign Application Priority Data
Nov. 5, 2004 (DE) 10 2004 053 426.8

(51) Int. Cl. G08B 13/14

(52) U.S. Cl. 340/572.1

(57) ABSTRACT

The present invention relates to a sensor device (100) for monitoring of merchandise (200), more specifically for monitoring movement of merchandise (200). For that purpose, a sensor device (100) is at least partly mounted on the merchandise (200) that is monitored and has at least one motion sensor (110).

The present invention also relates to a monitoring system (500) for monitoring the merchandise (200) as well as an operating procedure for using the monitoring system (500).

The present invention relates to a sensor device for monitoring merchandise, more specifically for monitoring a movement of merchandise.

The present invention moreover relates to a monitoring system for monitoring merchandise, more specifically for monitoring a movement of merchandise.

Moreover, the present invention relates to a method for using a monitoring system for monitoring merchandise, more specifically for monitoring the movement of merchandise.

Known sensor devices, monitoring systems, and methods for using monitoring systems of the prior type allow, for instance, to detect an attempt to steal merchandise that is being monitored. For that purpose, normally an electric conductor loop having a specially provided break point or a conventional switch contact is connected to the merchandise that is being monitored in such a manner that when the attempt is made, e.g., to detach the merchandise that is being monitored from the sensor device, the conductor loop is broken, and accordingly an alarm is activated.

The purpose of the present invention is to improve conventional sensor devices, monitoring systems, and methods for using monitoring systems in such a manner as to enhance operation while providing for more flexibility and easier handling.

This purpose is accomplished, according to the invention, in a sensor device of the prior type, by the fact that at least one part of the sensor device can be mounted on the merchandise that is being monitored, and by the fact that the sensor device has at least one motion sensor.

The motion sensor is especially advantageous when it is placed on that part of the sensor device which can be mounted on the merchandise and is subjected to the same motion as the merchandise itself whereby a movement of the merchandise that is being monitored can be detected directly by means of a signal received from the motion sensor.

More specifically, this configuration of the sensor device according to the invention can give evidence as to whether the merchandise has for example been removed by the customer from a stand provided for merchandise presentation.

Data of this kind, according to the invention, is not mainly used for activation of an alarm by means of the sensor device, but rather for determining the consumer intent of the customer or for controlling the presentation offers and/or for providing sale information on the merchandise.

In the case of an advantageous embodiment of the present invention it is designed in such a way that the sensor device has a signal transmission means, in particular for transmitting signals from the motion sensor to a processor device or the like. In this way a central recording and/or processing of the motion sensor signal can for example be made possible in this manner.

According to another advantageous embodiment of the present invention, the signal transmission features at least one cable connection. Alternatively, or even in addition to it, the signal transmission means may be provided with at least one wireless connection, e.g., radio link.

According to another advantageous embodiment of the present invention, a sender, more specifically for transmitting signals of the motion sensor to the processor device or the like is provided.

More specifically, a wireless connection or a radio link allows for a very flexible application of the sensor device according to the invention because the merchandise has to be connected only to the sensor device for monitoring. A sender that allows for radio communication with an evaluating processor device that can be remote from the merchandise is integrated in the sensor device so as to provide for the maximum possible freedom in placing the merchandise that is being monitored on the presentation stand. Further, the aesthetic image of the merchandise is not burdened with a cable connection of the sensor device with the evaluating processor that could also be visible and that can impair the external appearance of the presentation stand.

The motion sensor can be generally designed to sense the movement in space of the merchandise connected to it and to the sensor device.

According to another advantageous embodiment of the present invention, the motion sensor can comprise an inclination sensor, whereby the orientation in the room of the motion sensor or the merchandise, respectively, can be sensed

More specifically, a further embodiment of the present invention also provides for a motion sensor comprising an acceleration sensor.

According to another advantageous embodiment of the present invention the motion sensor is designed as an inclination sensor.

In a first modification of the motion sensor that is made as a mechanical inclination sensor, a contact body, e.g., a ball made of an electrically conducting material is movably mounted in a switch chamber having several switch contacts and connects electrically various switch contacts to one another depending on inclination of the inclination sensor.

In another modification of the inclination sensor, it is designed as a micromechanical inclination sensor, which, contrary to the above-described sensor modification, functions irrespective of position and exhibits a very high level of accuracy, e.g. an angular resolution of about 0.20°. In the most advantageous embodiments of this micromechanical inclination sensor, its response limit can even be programmed, and/or its idle state can be defined.

A modification of the motion sensor that is especially simple for implementation according to the invention is in the form of a switch, in particular a micro switch. The switch is so positioned that it changes its switching state when the merchandise with the sensor device is removed from the presentation stand.

The switch can also be positioned in the sensor device according to the invention in such a manner that it is actuated when the merchandise is put down on a level presentation surface so as to detect the merchandise removal and respectively the replacement.

Alternatively, to provide the motion sensor as a switch, more specifically as a micro switch, it is also conceivable that the motion sensor is made as a reed contact, so that the detection of removal and replacement of the merchandise can be sensed by means of a magnet that is provided in a part of the sensor device according to the invention. The magnet can at the same time be used for attachment to a magnetic holder, which can be used as a stand.

Furthermore, the motion sensor can also be made optical, more specifically as a reflected light photo sensor and/or a photo resistor, or the like.

According to another advantageous embodiment of the present invention, the motion sensor can also comprise capacitive or inductive sensor means and/or sensor means for sensing the position of the sensor device and/or a different sensor means.

It is especially advantageous, in another embodiment of the present invention, that the motion sensor is made as an electronic component, more specifically as a surface mounted device (SMD) component. In this modification of the invention, the motion sensor requires minimal space, whereby the sensor device containing the motion sensor can be made very compact. Moreover, such SMD motion sensor can be very easily integrated in a sensor device that is already available, such as for example for detecting theft attempts.

According to another advantageous embodiment of the present invention, the data on merchandise motion can be transmitted to a processor device, preferably at points of time that can be preset.

To enable a continuous monitoring of a movement of the merchandise, data should be transmitted on a regular basis to the processor device. For example, the merchandise can be monitored for movement at one-second intervals, and data transmission can be carried out at the same time step or at longer time intervals.

More specifically, with autonomous sensor devices having their own power supply and a wireless communication link with the processor device, it can be reasonable not to have the sender that is activated for wireless communication on a continuous basis, but to activate it only when data has to be transmitted via the wireless communication link.

It is especially advantageous that the switch described above for detecting merchandise removal from the presentation stand be used to activate sensor device motion monitoring, if other sensor means, e.g., acceleration sensors or position sensors are provided in addition to the switch as the motion sensor. These additional sensor means are only activated when the switch shows that the merchandise has been removed from the presentation stand. In the same manner these additional sensor means can be deactivated as soon as the switch shows that the merchandise that was removed from the presentation stand before has been replaced.

According to another very advantageous embodiment of the present invention, the sensor device can be integrated in an existing device for securing merchandise against theft.

Devices of this type are attached to merchandise being monitored, e.g., by means of two-sided adhesive tape and are connected by means of a wind-up cable connection to a support part, which is permanently provided on the presentation stand, with the device installation on the merchandise and/or on the presentation stand being monitored with alarm, e.g., by means of electronic contact loops or the like. In addition to the wind-up cable, a system exists with a conventional, i.e., non wind-up cable connection for example spiral cables and the like, which can also be used for integration of the sensor device according to the invention.

As soon as tempering with such contact loops is detected in the event of sabotage or an attempt to steal, the processor electronics announces an alarm condition, e.g., by an alarm sound signal.

A known retaining member of a merchandise security device, which is used for the sensor device according to the invention is described, e.g., in DE 102 49 460 A1.

Specifically when using a compact motion sensor in form of an SMD component, the sensor device according to the invention can be integrated directly in the retaining member provided for securing the merchandise, thus greatly enhancing the functionality of the retaining member.

In addition to pure theft monitoring, the retaining member provided with the sensor device according to the invention can also ensure the above-described monitoring of merchandise for movements. Appropriate data or signals of this motion sensor can be transmitted to a processor module, e.g., using the cable that is already available, although until now only used for security against theft or other connections, e.g., a wireless connection as well, more specifically a radio link.

It is also possible to process the data or signals of the motion sensor by means of a processor module that is already available for theft monitoring in the retaining member or elsewhere. By the same token, the sensor device according to the invention can be supplied from the retaining member power supply when it is integrated in the retaining member.

It is also conceivable that a radio link provided in the sensor device could be used by the processor module also for the purpose of theft monitoring, more specifically for transmission, e.g., of an alarm signal or the like.

According to another advantageous embodiment of the present invention, a signal transmission means that is available in the merchandise security device can be used for transmission of data from and/or to the sensor device, more specifically for transmission of data on merchandise movement.

According to another advantageous embodiment of the present invention the data on merchandise movement, and/or time data, and/or other data can be preferably stored in the sensor device.

In addition to the expansion of the available merchandise security device by means of the sensor device according to the invention, the sensor device itself can be provided with means for theft detection such as, e.g., micro switches, electrically conducting loops with break points and the like, as well as with processing electronics for theft attempt detection. Such sensor device will have dual functionality.

It is especially advantageous that the sensor device according to the invention be provided with sensor means for checking for proper mounting and connection of the sensor device to the merchandise and/or of the different parts of the sensor device to each other and/or to the presentation stand.

According to another advantageous embodiment of the present invention, at least one processor device is provided in the sensor device. This modification of the invention allows for providing an autonomous sensor device that can itself process the obtained signals, more specifically from the motion sensor. A connection to an external processor module can be accounted for in this case. It is however also reasonable to use the local processing module provided in the sensor device in parallel, or in alternation with a central processor module located outside the sensor device.

According to another advantageous embodiment of the present invention, at least one alarm device is provided in the sensor device. The alarm device can be a visual and/or a sound device. It is especially advantageous that a piezoelectric sound transducer is provided as the sound alarm device.

According to another advantageous embodiment of the present invention, the sensor device has at least two parts. With this configuration, e.g., the first part of the sensor device according to the invention with the motion sensor can be mounted on the merchandise, and the second part is provided for by attachment to the presentation stand. By means of, e.g., a cable connection between the two parts, a simple mechanical coupling of the merchandise being monitored to a fixed place is obtained. In addition to the purely mechanical coupling, the cable connection can be used for signal transmission, e.g., between the motion sensor accommodated in the first part and the processor device located in the second part.

It is also possible that the sensor device according to the invention be made of several parts, and that several parts are provided for being mounted on the merchandise being monitored, and, e.g., the first part can contain the motion sensor, with the second part containing sensor means for monitoring the second part for proper mounting on the merchandise.

According to another advantageous embodiment of the present invention, the motion sensor is so constructed that separation and/or connection of the parts is detectable. With a rigid connection of the first part to the presentation stand, with the second part being removable and contained in the first part, which is in turn connected to the merchandise, it is possible to detect whether the merchandise has been removed from the stand or it has been replaced. In this modification of the invention, the motion sensor is preferably made as a switch, more specifically as a micro switch.

According to another advantageous embodiment of the present invention, the sensor device has its own power supply, so that the autonomous use of the sensor device is possible.

According to another advantageous embodiment of the present invention, two motion sensors are provided in the sensor device. The first motion sensor can be so constructed as to detect, e.g., merchandise removal from and respectively replacement on the presentation stand, while the second motion sensor is designed as an inclination sensor, so that additional data on merchandise movement can be obtained upon removal and replacement.

Another solution to the problem of the present invention is represented by a monitoring system according to claim 21.

A monitoring system according to the invention for monitoring merchandise, more specifically for monitoring merchandise movement is characterized by at least one sensor device, which can be partly mounted on the merchandise and which has at least one motion sensor.

According to another advantageous embodiment of the present invention, the sensor device is designed according to one of claims 1 through 20.

In an especially advantageous embodiment of the monitoring system according to the invention, the processor evaluation device is provided for processing data obtained by the sensor device by means of merchandise movement. The processor device is preferably constructed in such a manner that it does not impair the aesthetic impression of the presentation stand and of the merchandise that is exhibited on it.

According to the invention, such a processor device can be provided for processing data obtained from several sensor devices on movement of respective merchandise.

According to another advantageous embodiment of the present invention, the monitoring system has a connection between the sensor device and the processor device. The connection can be provided, similarly to the sensor devices described above, as a cable connection or as a wireless connection, more specifically as a radio link.

In an especially advantageous embodiment of the present invention, the monitoring system has an information system for the presentation of sale and merchandise-related information. In this manner, an interested customer can automatically have information on the presented merchandise that is made available in the immediate proximity to the merchandise.

According to another advantageous embodiment of the present invention, the information system has a personal computer and/or a display device, more specifically, a flat panel display. The flat panel display can be easily integrated in the existing presentation stand without affecting its aesthetic impression.

By using the information system according to the invention, it is easy to have extensive information on the exhibited merchandise.

More specifically, with the monitoring system according to the invention, based on the data on movement of merchandise (articles of merchandise) obtained by means of the sensor device(s), the information system can present sale and merchandise-related information depending on the data on merchandise movement obtained by means of the sensor device.

More specifically hereby the combination according to the invention of the sensor device and a certain article of merchandise can be used in such a manner that when this certain article of merchandise is removed, the information exactly on this merchandise will be displayed or presented.

For that purpose, in processing the data obtained by the sensor device on movement of a certain article of merchandise in the processor device, corresponding information related to this merchandise will be requested from the information system.

It is also expedient to store the data obtained on merchandise movement together with a respective article of merchandise, so that based on such data, e.g., a conclusion on customer interest in certain articles can be drawn. Such data could be preferably made available for respective manufacturers in return for payment.

The information system can also be advantageously used, with the use of the invention, in combination with a device for securing merchandise against theft, in addition to the merchandise-specific information for customers, to display condition of the merchandise security device, which allows for an easy evaluation by operation personnel. In the same way the personal computer of the information system can be used for configuration, and/or communication, and/or coordination of many merchandise security devices.

Another solution to the problem of the invention is represented by a method for using the monitoring system according to claim 29. In a method that is specifically provided for monitoring merchandise movement, in which at least one sensor device, which is at least partly mounted on the merchandise that is being monitored, obtains data on merchandise movement by means of at least one motion sensor, sale and merchandise -related information is presented depending on the data obtained on merchandise movement.

According to another advantageous embodiment of the present invention, the sensor device according to one of claims 1 through 20 is used.

According to another advantageous embodiment of the present invention, the monitoring system of one of claims 21 through 28 is used.

According to another advantageous embodiment of the present invention, sale and merchandise-related information is presented depending on the position of the merchandise in space and/or orientation of the merchandise in space, and/or on the detected time of merchandise observation, and/or on the time of the day, and/or time of the year, or the like.

It is therefore, possible, e.g., depending on customer preferences, to present detailed information by means of the information system.

For example, according to the invention, the observation time, i.e., the time for which merchandise has been taken, e.g., by an interested customer from the presentation stand for review, is obtained, e.g., by means of the processor device. Depending on this observation time, e.g., different data can be provided. When the merchandise is removed from the presentation stand, e.g., a short video sequence can be played back, which provides basic information on the merchandise that has been picked up. As soon as the observation time exceeds a certain preset time, it should be concluded from this that the customer who is reviewing the merchandise is possibly interested in more information, which will be then made available for him by means of the information system.

By using the present invention, extensive and competent information of the customers can therefore be ensured without surplus personnel, the information being especially flexible, serviceable, and user friendly because of the use of a personal computer as the information system.

In addition to extensive information on customers, the invention also provides an advantage of conducting an analysis of the customers' interests and customers' attitudes with respect to review of the merchandise exhibited on the presentation stand inconspicuously for the customers. The results of such analysis can be sold by the information system operator or used for optimizing the sale strategies.

Integration, according to the invention, of the sensor device according to the invention in the retaining member of an existing merchandise monitoring security system is especially advantageous, whereby the above-mentioned advantage of easier maintenance of the monitoring system and, only minimum configuration changes compared to conventional monitoring systems are helpful.

Increasing the functionality of conventional monitoring systems regarding their merchandise security functions can also be accomplished by the invention. For that purpose, it is, e.g., possible to process the observation time obtained according to the invention or even the detected movement of the merchandise and to activate an alarm based on striking parameters for the observation time or in case of suspicious motion patterns.

In case of the wireless connection of the sensor device with the processor module, it is especially advantageous and also possible that the entire sensor device be not mounted on the merchandise, but rather the sensor device be placed inside the merchandise, more specifically, concealed, e.g., in the battery compartment or the like.

Monitoring the sensor device for proper mounting on or inside the merchandise by using conventional methods and devices, e.g., with electrically conducting loops or switch contacts between the sensor device and the merchandise is also possible in order to detect separation of the sensor device according to the invention from the merchandise.

Other features, application examples, and advantages of the present invention will be apparent from the following description of the figures with reference to the drawing, in which:

FIG. 1 schematically shows a first embodiment of the present invention,

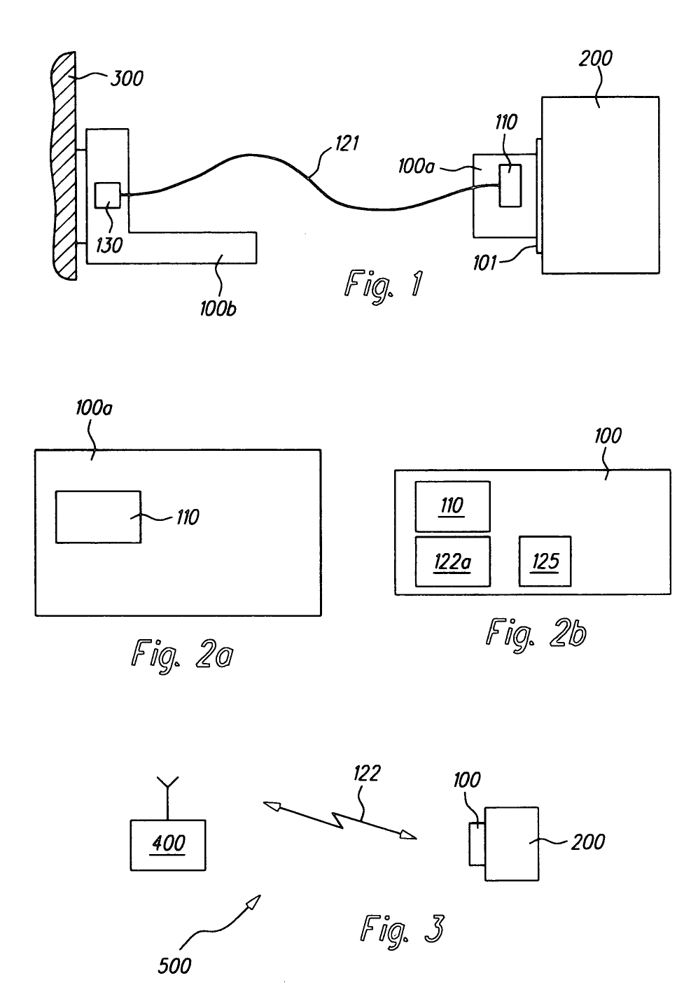

FIG. 2a is a block-diagram of a sensor device according to the invention,

FIG. 2b is a block-diagram of another embodiment of the sensor device according to the invention,

FIG. 3 is an embodiment of a monitoring system according to the invention;

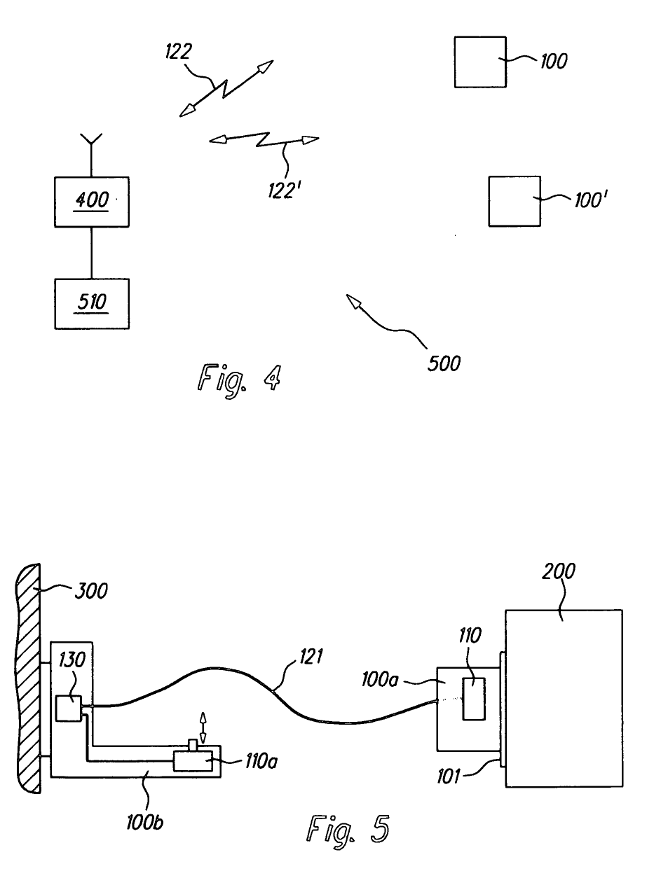

FIG. 4 is another embodiment of a mentoring system according to the invention,

FIG. 5 is another embodiment of a sensor device according to the invention,

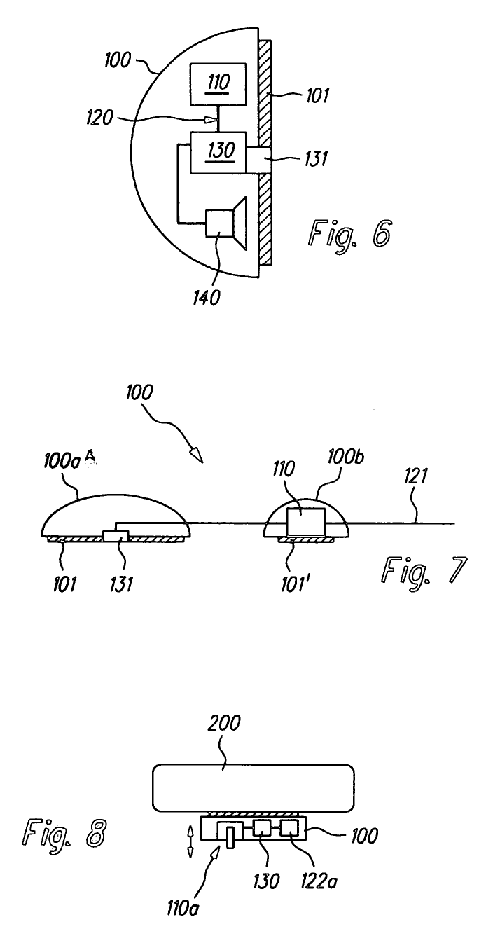

FIG. 6 is another embodiment of a sensor device according to the invention,

FIG. 7 is another embodiment of a sensor device according to the invention, and

FIG. 8 is another embodiment of a sensor device according to the invention.

FIG. 1 shows a first embodiment of the present invention, in which a first part 100a of a sensor device 100 according to the invention is attached to an article of merchandise 200 by means of a two-sided adhesive tape 101.

A second part 100b of the sensor device 100 shown in FIG. 1 is rigidly connected to a presentation stand 300 for exhibition of the merchandise 200 in a sales area and preferably has a cable drum, which is not shown in FIG. 1 for winding up a cable connection 121 in the second part 100b.

Further, the second part 100b is designed to retain the first part 100a, e.g., by means of a rabbet joint not shown in FIG. 1, so that the merchandise 200 with the first part 100a mounted on it can be mounted through the second part 100b on the presentation stand 300.

The sensor device 100 according to FIG. 1 is provided, according to the invention, with a motion sensor 110, which is mounted on the first part 100a of the sensor device 100 as shown. Because the first part 100a, as mentioned above, is attached to the merchandise 200 preferably by means of a detachable adhesive joint, the first part 100a and the motion sensor 110, which is mounted therein according to the invention, are subjected to the same motions as the merchandise 200.

In this manner, it is possible, according to the invention, to detect, e.g., removal of the merchandise 200 from the presentation stand 300. In the same manner, putting the merchandise 200 on the presentation stand 300 can be detected by the motion sensor 110 according to the invention.

Depending on the type of the motion sensor 110, for example, acceleration of the merchandise 200, orientation of the merchandise 200 in space, or even position of the merchandise 200 in space can be detected.

In a preferred embodiment of the motion sensor 110 as an inclination sensor, a contact body, such as a ball made of an electrically conducting material is movably mounted in a switch chamber having several switch contacts and connects electrically different switch contacts with one another depending on inclination of the inclination sensor.

In another especially advantageous modification of the inclination sensor, it is made as a micromechanical inclination sensor, which, in contrast to the above-described sensor modification having the conducting ball, functions irrespective of position, and has very high accuracy, e.g., with an angular resolution of about 0.2°. In an especially advantageous embodiment of this micromechanical inclination sensor, its response limit can even be programmed, and/or an idle state can be defined.

For processing the motion obtained from the motion sensor 110, the second part 100b of the sensor device 100 is provided with a processor device 130, which is connected to the motion sensor 110 by means of a cable connection 121.

In addition to the motion sensor 110 according to the invention, the sensor device 100 can also be provided with sensor means known from the art, preferably of the electronic type, which should secure the proper mounting of the first part 100a on the merchandise 200. Such sensor means can be made, e.g., as a micro switch or in the form of electrically conducting loops, which are broken or destroyed when the merchandise 200 is separated from the first part 100a, whereby sabotage or a theft attempt can be detected.

Detection of such theft attempt is ensured, e.g., in the processor module 130, and the existing cable connection 121 of the first part 100a is at the same time used for connection of the processor module 130 to the sensor means provided in the first part 100a (not shown).

Similarly to the connection between the first part 100a and the merchandise 200, the cable connection 121 and/or in general a connection between the first part 100a and the second part 100b with the processor module 130 can be monitored for sabotage based on separation of the cable connection 121. Similar monitoring can be also provided to detect unauthorized separation of the second part 100b from the presentation stand 300.

The block diagram shown in FIG. 2a shows an enlarged view of the part 100a of the sensor device shown in FIG. 1. As can be seen in FIG. 2a, the sensor device 100 has in its first part 100a the motion sensor 110 mentioned above.

In an especially advantageous embodiment of the present invention, the motion sensor 110 according to the invention is made as an electronic component, more specifically as an SMD (surface mounted device) component. This modification represents a very compact embodiment, whereby such sensor device 100 can be easily integrated in an already existing merchandise security system or in the retaining member of such merchandise security system.

Another advantageous embodiment of the sensor device 100 according to the invention is shown in FIG. 2b. The sensor device 100 shown here consists, in contrast to the modification shown in FIG. 1, of one part 100 only and, in addition to the motion sensor 110 described above, it has a sender 122a, which is used to provide a wireless connection, such as the one used, e.g., in a monitoring system 500 according to the invention, shown in FIG. 3. Alternatively, or in addition to the sender 122a, a cable connection that is not shown (cf. FIG. 1) between the sensor device 100 and the processor circuit or the like can be provided. For power supply, among other things, of the motion sensor 110 and sender 122a, the sensor device 100 according to FIG. 2b is provided with a power supply 125.

In the embodiment of the present invention shown in FIG. 3, the sensor device 100 according to the invention is again designed as a single piece and is attached directly to the merchandise 200. This attachment can also be accomplished by means of a two-sided adhesive tape (cf. FIG. 1) and/or can have alarm monitoring.

By means of the sender 122a, which is provided in the sensor device 100 of FIG. 3 and is shown, e.g., in FIG. 2b, a radio link 122 is provided in a monitoring system 500 according to the invention between the sensor device 100 and a processor device 400. The radio link 122 is used here, e.g., for transmission of data on movement of the merchandise 200, which can be detected by means of the motion sensor 110 (FIG. 2b) integrated in the sensor device 100. The data on movement of the merchandise 200 can be stored in the processor module 400 shown in FIG. 3, or it can be immediately processed, e.g., with regard to detection of removal of the merchandise 200 from the presentation stand 300 (cf. FIG. 1) or replacement of the merchandise 200 thereon or the like.

Regardless of whether the inventive sensor device has the cable connection 121 (FIG. 1) or the radio link 122 (FIG. 3), or both connection versions are supported, several sensor devices can be used simultaneously in the monitoring system 500 according to the invention, whereby several different articles of merchandise can be monitored for movement or the like simultaneously.

It is especially advantageous in another embodiment of the monitoring system 500 according to the invention that the data on movement of the merchandise 200 be stored and used for analyzing customer preferences. For example, based on the observation time, i.e., for the time frame during which the merchandise 200 has been removed from the presentation stand 300, a conclusion could be made, e.g., about the interest of the customers in this particular article of merchandise. In carrying out simultaneous monitoring of different articles of merchandise by means of several sensor devices according to the invention, it is possible in this manner, to learn which articles of merchandise are most intensively reviewed by the customers and which articles of merchandise are less intensively observed.

This information can be used for optimizing the arrangement of the merchandise on the presentation stand 300 (FIG. 1).

It is especially advantageous in another embodiment of the monitoring system 500 according to the invention as shown in FIG. 4 that the processor device 400 be so constructed as to support several radio links 122, 122′ to different sensor devices 100, 100′ as shown with double arrows 122, 122′ in FIG. 4. In this manner, it is possible to at the same time obtain the motion condition of several articles of merchandise (not shown in FIG. 4) by using a single processor device 400.

It is especially advantageous that the monitoring system 500 of FIG. 4 according to the invention have, in addition to the central processor module 400 and several sensor devices 100, 100′, also an information system 510, which is provided for the presentation of sale and merchandise-related information. For that purpose, the information system 510 is provided, e.g., with a personal computer (PC, which is not shown) and a display device, more specifically in the form of a flat panel display (not shown).

The flat panel display of the information system 510 can be most preferably inconspicuously integrated in the presentation stand 300 (FIG. 1) used for exhibition of the merchandise 200 without impairing the aesthetic impression of the merchandise 200.

For individual and convenient information to customers who are interested in the merchandise 200, the processor module 400 processes the motion data on certain articles of merchandise 200 obtained via the radio links 122, 122′, and, depending on the data on movement of the merchandise 200, controls information in the information system 510. In response, the information system 510 presents, e.g., technical data of the corresponding article of merchandise 200, additional detailed information or possible usage and advantages of the merchandise, and the like.

It is especially advantageous in the design of the monitoring system 500 according to the invention as shown in FIG. 4 that the processor module 400 has data as to exactly which article of merchandise has been moved. In this manner, it is possible according to the invention, by appropriately controlling the information system 510, to offer sale information specifically on the article of merchandise 200 that has been moved.

According to another very advantageous embodiment of the invention, the observation time for the merchandise 200 that has been moved be analyzed, and, depending on the observation time, e.g., different sale information could be made available from the information system 510.

It is, e.g., conceivable, that general product information be presented by means of the information system 510 as soon as a certain sensor device 100 (FIG. 1) detects removal of the merchandise 200 from the presentation stand 300. When a preset observation time is exceeded, i.e., when the merchandise 200 that was removed has not been replaced on the presentation stand 300 (FIG. 1) for a long time, further detailed information on the respective article of merchandise 200 is sent to the display device of the information system 510. It is also possible that sale and merchandise-related information be presented depending on position of the merchandise in space, and/or orientation of the merchandise in space, and/or time of the day, and/or time of the year, and the like. In order to obtain the merchandise position and orientation in space, special appropriate sensors are provided in the sensor device 100, which are added to, or replace the described motion sensor.

In addition to control of the information that is of interest for customers by means of the information system 510, the data on movement of the merchandise 200 by means of the sensor device 100 can also be used for theft monitoring and as an addition to theft monitoring. For example, when the observation time is exceeded or when a suspicious movement of the merchandise 200 is recorded, an alarm is activated.

In the event that the wireless connection 122, 122′ between the sensor device 100 and the processor module 400 is used, the entire sensor device 100 preferably is not mounted on the merchandise 200, but rather the sensor device 100 is placed in the merchandise, e.g., concealed in the battery compartment or the like. In addition to the data on movement of the merchandise 200 for the information purposes, this can also provide for efficient security against theft, e.g., by the fact that the sensor device 100 activates its sender 122a (FIG. 2b) when the merchandise 200 is removed from the presentation stand 300, and, as described, transmits the data obtained from the motion sensor 110. An additional receiver for signals that are sent from the sensor device 100 and its sender 122a can activate an alarm placed, e.g., at the exit from the sales area as soon as the signal is received.

In another especially advantageous embodiment of the sensor device according to the invention, the data on merchandise movement and/or the time data, and /or other data are stored by the sensor device 100 itself, whereby the data can be requested as required.

In another especially advantageous embodiment of the sensor device 100 according to the invention (see FIG. 5) in addition to the motion sensor 110 located on the first part 100a, another motion sensor 110a is provided, which is located in the second part 100b of the sensor device 100.

The second motion sensor 110a, unlike the first motion sensor 110, which is made as an inclination sensor, is made as a micro switch 110a, and it is used to detect the removal of the first part 100a mounted on the merchandise 200 from the second part 100b of the sensor device 100 according to the invention. For that purpose, the micro switch 110a, as shown in FIG. 5, is so designed that it is in the first switch position when the second part 100b is mounted on the first part 100a, and it is set to the second switch position by the removal of the first part 110a from the second part 100a as shown by the double arrow in FIG. 5.

The switch position of the micro switch 110a is monitored by the processor device 130.

As an alternative to positioning the micro switch 110a in the second part 100b of the sensor device 100, the micro switch 110a can be provided in the first part 100a of the sensor device 100, which is attached to the merchandise 200, and in that case, it is connected to the processor device 130 by means of the cable connection 121.

The multiple-part sensor device according to the invention as shown in FIG. 5 can also be made with a single motion sensor made as the micro switch 110a, i.e., without a motion sensor made as an inclination sensor or the like. In this case, the merchandise 200 is also monitored for removal from the presentation stand 300 and for replacement on the presentation stand 300.

Another especially advantageous embodiment of the sensor device 100 according to the invention is shown in FIG. 6. This sensor device 100 is attached by means of a two-sided adhesive tape 101 to an article of merchandise 200 (FIG. 1) that is not shown in FIG. 6 and has the motion sensor 110 made as an inclination sensor, which is also connected to the processor device 130, which is provided in the sensor device 100, by means of a connection 120. A power supply 125 (cf. FIG. 2b) is also provided in the sensor device 100 of FIG. 6, which is not shown in FIG. 6 for the sake of clarity.

In addition to the inclination sensor 110, the sensor device 100 of FIG. 6 also has electronic sensor means 131 for checking for proper mounting of the sensor device 100 on the merchandise 200, which is also connected to the processor device 130.

To give an alarm signal, the sensor device 100 of FIG. 6 is additionally provided with a sound alarm device 140, more specifically, with a piezoelectric sound transducer.

As soon as the processor device 130 detects tempering with the attachment of the sensor device 100 to the merchandise by means of the sensor means 131, the corresponding sound alarm is given. In addition, or alternatively a visual alarm signal can be provided.

The data obtained from the motion sensor 110 is also processed in the processor device 130, and may be used to detect theft. For example, the observation time for the merchandise 200 connected to the sensor device 100 is obtained for that purpose, and when the preset limit value is exceeded, i.e., when the merchandise 200 has not been replaced on the presentation stand within the preset time, an alarm is activated.

The embodiment of the sensor device 100 according to the invention that was described above with reference to FIG. 6 functions autonomously, and it does not need any central processor device 400 as provided for the invention modification shown in FIG. 4.

It is, however, also possible that the sensor device described with reference to FIG. 6 be provided with a sender 122a (FIG. 2b), so that the data processed in the processor device 130 can be transmitted to the central processor device 400 having the presentation system 510 (FIG. 4).

Show window doors or other objects can be, e.g., monitored for movement by means of the self-sufficient sensor device (100) according to FIG. 6 in the centralized or decentralized manner, so that the sensor device according to the invention can replace glass break protection as well.

Seen as a whole the invention can be used for recording data on movements of the merchandise being monitored for the sale purposes and the like and, at the same time, it can check almost any object for theft and unauthorized movement.

Another modification of the sensor device 100 according to the invention is shown in FIG. 7. The sensor device of FIG. 7 has the first part 100a and the second part 100b. Both parts 100a, 100b are each provided with a two-sided adhesive tape 101, 101′ for attachment to the merchandise 200 being secured (FIG. 1), and are connected by means of the cable connection 121.

The above-described sensor means 131 for checking for correct mounting of the sensor device 100 and first part 100a on the merchandise 200 is provided in the first part 100a, and the motion sensor 110 according to the invention is provided in the second part 100b, the motion sensor being made as an inclination sensor in this modification of the invention.

The sensor means 131 is connected by means of the cable connection 121 to the motion sensor 110 and to the processor device 400, which is not shown (see FIG. 4), which ensures theft monitoring and movement of the merchandise 200 (FIG. 1).

In principle, at least one motion sensor 110 and/or at least one sensor means 131 can be provided in each part 100a, 100b of the sensor device. It is also possible to provide a separate cable connection or a radio link for both the motion sensors 110 and sensor means 131.

One more embodiment of the sensor device 100 according to the invention is shown in FIG. 8. In this embodiment, the sensor device 100 is again made as a single piece, and it is attached to the merchandise 200 by means of a two-sided adhesive tape.

The sensor device 100 of FIG. 8 has only one motion sensor 110a, which is made as a micro switch 110a and which is installed on the sensor device 100 in such a manner that for example when the merchandise 200 is laid on level ground (not shown), it is set to the first switch position, in which the switch actuator of the micro switch 110a is, e.g., pressed into the housing of the micro switch 110a.

When the merchandise 200 is removed for observation by a customer, the switch actuator will no longer be pressed in under gravity of the merchandise 200 and the sensor device 100 and be held in the first switch position, and it will transfer to the second switch position. This change is shown in FIG. 6 symbolically by a vertical double arrow, and it is processed by the processor device 130 provided in the sensor device 100. In this manner, the removal and replacement of the merchandise 200 in the invention modification of FIG. 8 can also be detected, whereby the possibilities for processing of the obtained movements and the like described above can be used.

It is especially advantageous that the sensor device of FIG. 8 be provided with the sender 122 connected to the processor device 130 in order to transmit the obtained motion data to the central processor device.

The sensor device according to the invention can in general have one or several motion sensors 110, 110a, and these can be made as, e.g., inclination sensors, acceleration sensors, and the like, and/or also as switches, more specifically micro switches.

A motion sensor made as a switch, more specifically a micro switch 110a can also be provided in the part of the sensor device according to the invention that is rigidly secured to presentation stand 300 (FIG. 1) in order to monitor the proper mounting of this part of the sensor device on the presentation stand. Alternatively, this problem can be solved by means of a motion sensor made as an inclination sensor, which respectively monitors movement of the part of the sensor device according to the invention that is connected to the presentation stand 300 (FIG. 1).

When the sensor device according to the invention is provided with sensor means for checking the proper mounting of the sensor device on the merchandise, a separate processor device can be provided for processing signals obtained from the sensor means and the motion data from the motion sensor, respectively.

Alternatively to providing the motion sensor as a switch, more specifically as a micro switch, it is also possible to design the motion sensor as a reed contact, so that detection of removal and replacement of the merchandise can be provided by means of a magnet mounted in a part of the sensor device according to the invention.

1. A sensor device for monitoring merchandise, comprising: at least one part mounted on the merchandise being monitored; and at least one motion sensor.

2. The sensor device of claim 1, further comprising signal transmission means, for transmission of signals of the at least one motion sensor to another device.

3. The sensor device of claim 2, wherein the signal transmission means includes at least one cable connection.

4. The sensor device of claim 2, wherein the signal transmission means includes at least one wireless connection or radio link.

5. The sensor device of claim 1 further comprising a sender for transmission of signals of the motion sensor to another device.

6. The sensor device of claim 1 wherein the motion sensor comprises at least one of an inclination sensor, an acceleration sensor, a switch, capacitive or inductive sensor, means for detecting position of the sensor devices, and another sensor.

7. The sensor device of claim 1, wherein the motion sensor is designed as an electronic component.

8. The sensor device of claim 1, wherein the motion is made as an inclination sensor, in which a contact body is movably mounted in a switch chamber having several switch contacts and connects electrically the switch contacts with one another depending on inclination of the inclination sensor.

9. The sensor device of claim 1, wherein the motion sensor is a switch.

10. The sensor device of claim 1, wherein at least one processor device provided in the sensor device.

11. The sensor device of claim 1 wherein at least one device for outputting at least one alarm signal is provided in the sensor device.

12. The sensor device of claim 1, wherein the sensor device comprises at least two parts.

13. The sensor device of claim 12, wherein the motion sensor is made in such a manner that at least one of separation and connection of the parts is detectable.

14. The sensor device of claim 1, wherein the sensor device includes its own power supply.

15. The sensor device of claim 1, wherein two motion sensors are provided in the sensor device.

16. The sensor device of claim 1, wherein the data on movement of the merchandise is transmittable to the processor device.

17. The sensor device of claim 1, wherein the sensor device is integrated in an existing device for securing the merchandise against theft.

18. The sensor device of claim 17, wherein signal transmission means for securing the merchandise is usable for transmission of data at least one of from and to the sensor device.

19. The sensor device of claim 1. wherein at least one of the data on movement of the merchandise, time data, and other data stored in the sensor device.

20. The sensor device of claim 1, wherein the sensor means is provided for checking for proper mounting and connection of at least one of the sensor device to the merchandise and of the different parts of the sensor device to at least one of each other and to a presentation stand.

21. A monitoring system for monitoring an article of merchandised comprising: at least on sensor device including at least one motion sensor, the at least one sensor device being at least partly mounted on the merchandise that is being monitored.

22. (canceled)

23. The monitoring system of claim 21, wherein a processor device is provided for processing the data obtained by the sensor device on movement of the merchandised.

24. The monitoring system claim 23, further comprising a connection between the sensor device and the processor device.

25. The monitoring system of claim 21, further comprising an information system for presentation of sale and merchandise-related information.

26. The monitoring system claim 25, wherein the information system comprises at least one of a personal computer and a display device.

27. The monitoring system of claim 25, wherein at least one of the information system and the display device is integrated in a presentation stand.

28. The monitoring system of claim 25, wherein the information system is configured to present sale and merchandise-related information depending on the data on movement of the merchandise obtained via the sensor device.

29. A method for using a monitoring system for monitoring merchandise comprising: obtaining data on movement of the merchandise via a sensor device, the sensor device being mounted at least partly on the merchandise that is being monitored and including at least one motion sensor; and presenting sale and merchandise-related information depending on movement of the merchandise.

30. (canceled)

31. (canceled)

32. The method of claim 29, wherein sale and merchandise-related information is presented depending on at least one of position of the merchandise in space, orientation of the merchandise in space, obtained observation time for the merchandise, time of the day, and time of the year.

33. The method of claim 29 wherein the obtained data on movement of the merchandise is stored for subsequent processing.

34. The method of claim 29, wherein an alarm is activated depending on the data on movement of the merchandise.

35. The sensor device of claim 1, wherein the sensor device is for monitoring movement of the merchandise.

36. The monitoring system of claim 21, wherein the system is used for monitoring movement of the merchandise.

37. The method of claim 29, wherein the system is used for monitoring movement of the merchandise.

38. The sensor device of claim 1, wherein the motion sensor is designed as a surface mounted device component.
